(19) United States
(12) Patent Application Publication
(10) Pub. No.: US 2008/0182671 A1
(43) Pub. Date: Jul. 31, 2008

(54) Personal computer and/or laptop (notebook type) computer accessory used for computer gaming

(76) Inventor: Anton Steven Hucks, Perth (AU)

Correspondence Address: ANTON STEVEN HUCKS, 1185 STONEVILLE ROAD MUNDARING, PERTH, WA, 6073, omitted

(21) Appl. No.: 11/986,754

(22) Filed: Nov. 27, 2007

(30) Foreign Application Priority Data
Jan. 31, 2007 (GB) GB0701772.6

(51) Int. Cl. G06F 17/00

(52) U.S. Cl. 463/47

(57) ABSTRACT

A computer accessory, primarily intended for the activity of playing computer games, being an apparatus which, when attached to a personal computer flat screen monitor or laptop (notebook type) computer monitor, effectively partitions the monitor's screen area into four segments, each one of which, as a consequence of the attachment of the apparatus to the monitor, then becomes visible to one, only, of four separate persons (players) sat around the computer monitor and apparatus in a classic North-South-East-West configuration, ideal for playing indoor games.

### CROSS-REFERENCE TO RELATED APPLICATIONS

This application is a United States filing of Great Britain application number GB0701772.6 filed Jan. 31, 2007 and thereby claims right of priority under 35 U.S.C. 119.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM, LISTING COMPACT DISC APPENDIX

Not Applicable

### FIELD OF THE INVENTION

The invention relates to the field of computers and computer accessories, and more specifically to computer accessories for laptop (notebook type) computers and/or desktop computers with flat screen monitors. More particularly, the invention pertains to the field of computer accessories, which primarily provide or enhance the capability of the computer being used for the playing of games. However, further uses for the invention, other than gaming, are also possible.

### BACKGROUND OF THE INVENTION

Flat screen monitors are becoming increasingly common for use with desktop computers; laptop (notebook type) computers are everywhere to be seen; and the use of computers for playing games has been commonplace for some time. However, the majority of computer games played tend to involve only one player—the person who is simultaneously operating the computer. The main exception to this occurs when multiple computers, each with their own operator, are linked together over a network (e.g. the internet), enabling multiple persons (players) to play with (and/or compete against) each other. One example of this might be the whist game of cards, commonly called “Hearts”.

Accordingly, this invention allows multiple (up to four) players in the same physical location to use just one computer—either a laptop (notebook type) computer or a desktop computer with a flat screen monitor—to play any computer game, which can be configured for two, three or four players. Other examples of games for multiple players using multiple computers, such as simulated car racing games, often have complex constantly changing graphics displayed on the computers' monitors, which cause the games' programs to be heavy users of the computers' CPUs (Central Processing Units.) With computers becoming increasingly powerful, games such as those just described may soon—if not already—be able to be played on one single computer. Accordingly, this invention also allows the possibility of the playing of such games by multiple players using just one single computer.

### BRIEF SUMMARY OF THE INVENTION

The invention is an apparatus, which, when attached to a personal computer flat screen monitor or laptop (notebook type) computer monitor, effectively partitions the monitor's screen area into four segments, each one of which, as a consequence of the attachment of the apparatus to the monitor, then becomes visible to one, only, of four separate persons (players) sat around the computer monitor and apparatus in a classic North-South-East-West configuration, ideal for playing indoor games. This is achieved by an ‘X’ shaped frame, integral to the apparatus, which either supports mirrors or to which mirrors are permanently affixed or a combination of both.

When the apparatus is used in conjunction with computer software, which selectively displays information in mirror image format on the monitor, it becomes possible for two, three, or four people to use one single personal computer with a flat screen monitor or one single laptop computer in order to play any indoor game, which requires players to not reveal their playing pieces (cards, dice, tokens etc.) to other players, and which can be adapted to be played on a computer, and where some or all of the physical playing pieces are replaced by visual representations of themselves.

With the addition of some extra hardware (available at most computer outlets), specifically in the form of one, two, three, or even four small “USB” (Universal Serial Bus) Numeric Keypads, connected to the computer via a 4-way “USB” hub, it then becomes possible for each of the multiple (up to four) players to be able to enter input data to the computer game's program without recourse to the computer's main keyboard or the computer's mouse. Such a configuration, as described (the apparatus, the software, and the hardware) might also be utilised in non-gaming situations, one example of which could be a situation, where an interviewer required some form of immediate and dynamic evaluation of one, two, or three interviewees.

### BRIEF DESCRIPTION OF THE SEVERAL VIEWS OF THE DRAWINGS

The believed novel characteristics of the invention are set forth in the appended claims. The foregoing aspects and attendant advantages of the invention will best be understood by reference to the following detailed description of a preferred embodiment of the invention when read in conjunction with the accompanying drawings, wherein:

FIG. 1 shows the preferred embodiment of the invention in use on a laptop (notebook type) computer;

FIG. 2 shows the preferred embodiment of the invention, standing alone, almost fully assembled, in preparation for being mounted onto a flat screen monitor or a laptop (notebook type) computer monitor;

FIG. 3 illustrates how software must display information on the computer's monitor for the preferred embodiment of the invention;

FIG. 4 shows the first component—a flat rectangular frame—of the six components that comprise the preferred embodiment of the invention;

FIG. 5 shows the second component—a central X frame assembly, in its collapsed state—of the six components that comprise the preferred embodiment of the invention;

FIG. 6 shows a detail of the two components from FIG. 4 and FIG. 5, illustrating how these components join together;

FIG. 7 shows one of three identical components (the third, fourth, and fifth components)—a transparent triangular plastic clip—of the six components that comprise the preferred embodiment of the invention;

FIG. 8 shows the final component—a support cap—of the six components that comprise the preferred embodiment of the invention;

FIG. 9 shows a cross section of the central cylindrical pole, which is part of the central X frame assembly component shown in FIG. 5.

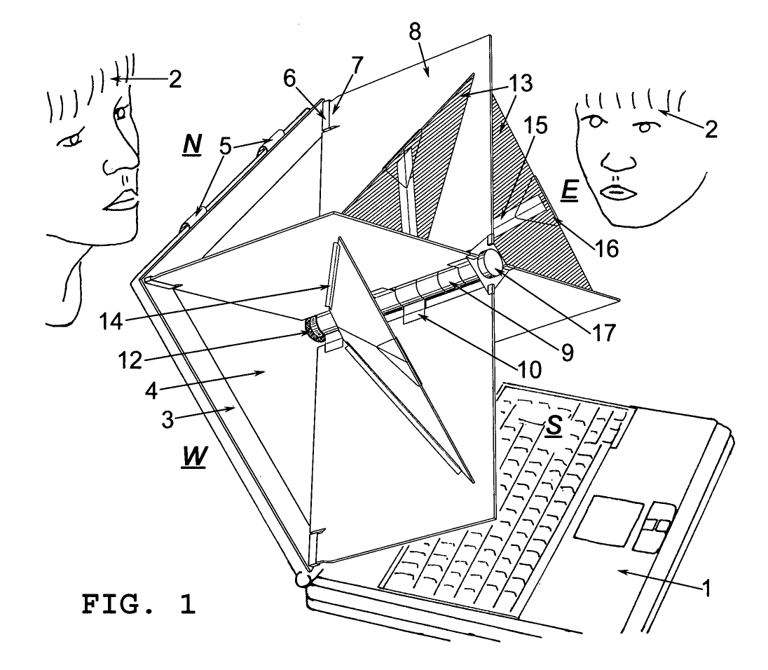

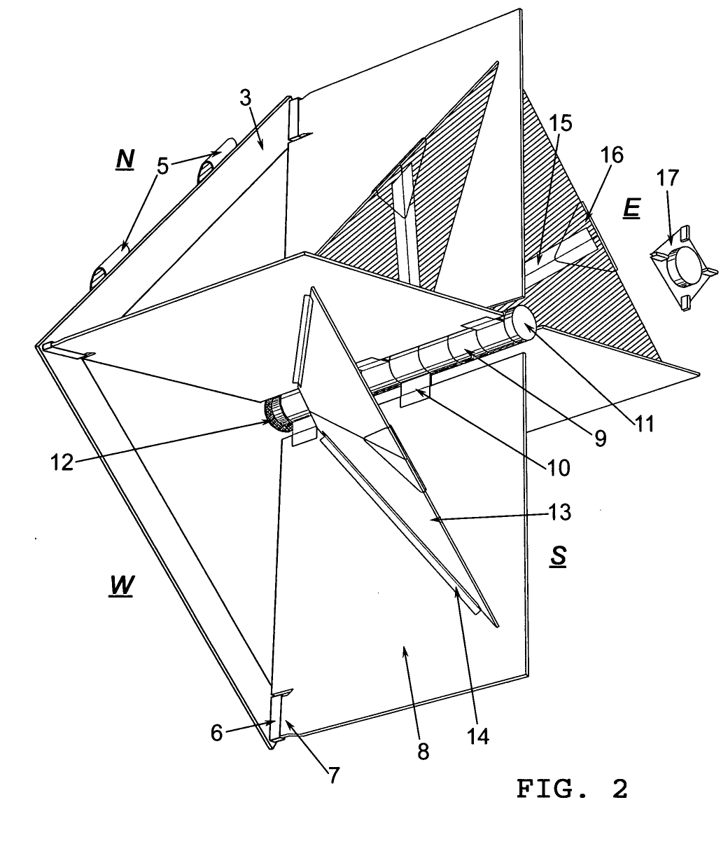

Please note that in FIG. 1 and FIG. 2, the letters N, E, W and S have been shown to indicate North, East, West and South, because the associated descriptions make reference to specific playing positions and/or those parts of the invention, which correspond to specific playing positions.

### DETAILED DESCRIPTION OF THE INVENTION

Because the invention is expected to be used, not only with desktop personal computers with flat screen monitors, but also with portable laptop (notebook type) computers, it has therefore been designed to be collapsible, so that it may be placed inside a pocket of suitable size of a portable computer's carry-case.

FIG. 1 shows the apparatus, assembled, mounted, and in use on a laptop (notebook type) computer (1), with a player (2) in the North (N) playing position and a player (2) in the East (E) playing position. In contrast, FIG. 2 shows only the apparatus standing alone, completely assembled except for the final component.

Referring to both FIG. 1 and FIG. 2, the apparatus consists of six separate components, the first of which is a flat rectangular frame (3), which is just large enough to surround the computer monitor's screen area (4) without concealing any portion of it.

The flat rectangular frame (3) has two retaining hooks (5), which are used to support the weight of the whole apparatus when it is mounted ready for use on the computer monitor. The retaining hooks (5) should be made of a soft pliable metal, so that they can easily be bent by hand into a shape suitable for the computer monitor used. Furthermore the retaining hooks (5) should preferably be covered with a flexible ‘cloth-like’ plastic, so that the metal cannot come into immediate contact with the computer monitor, thereby safeguarding the computer monitor from scratches, should the apparatus be mounted onto the computer monitor without due care.

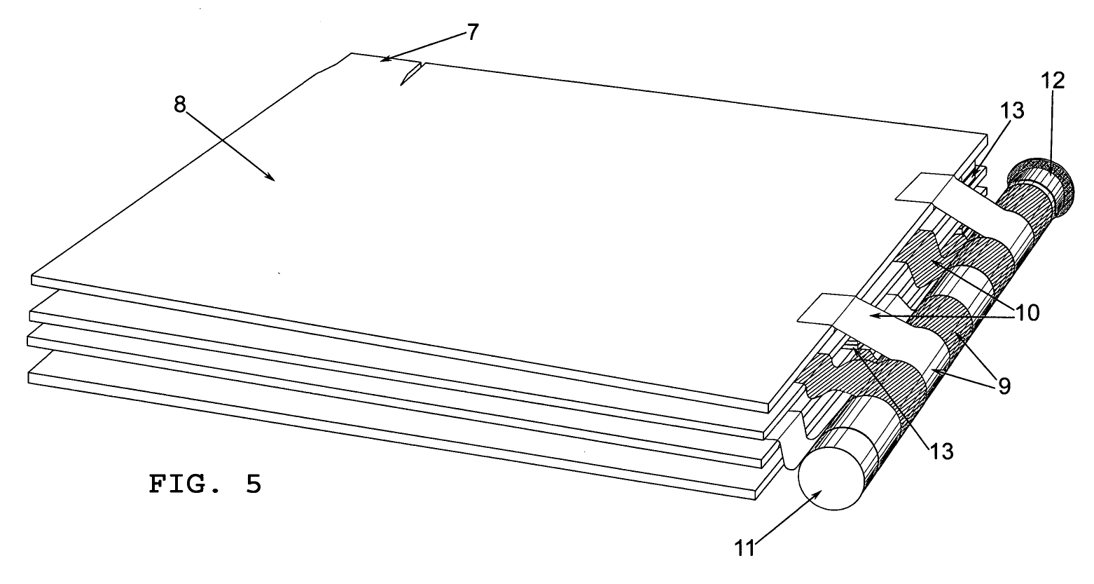

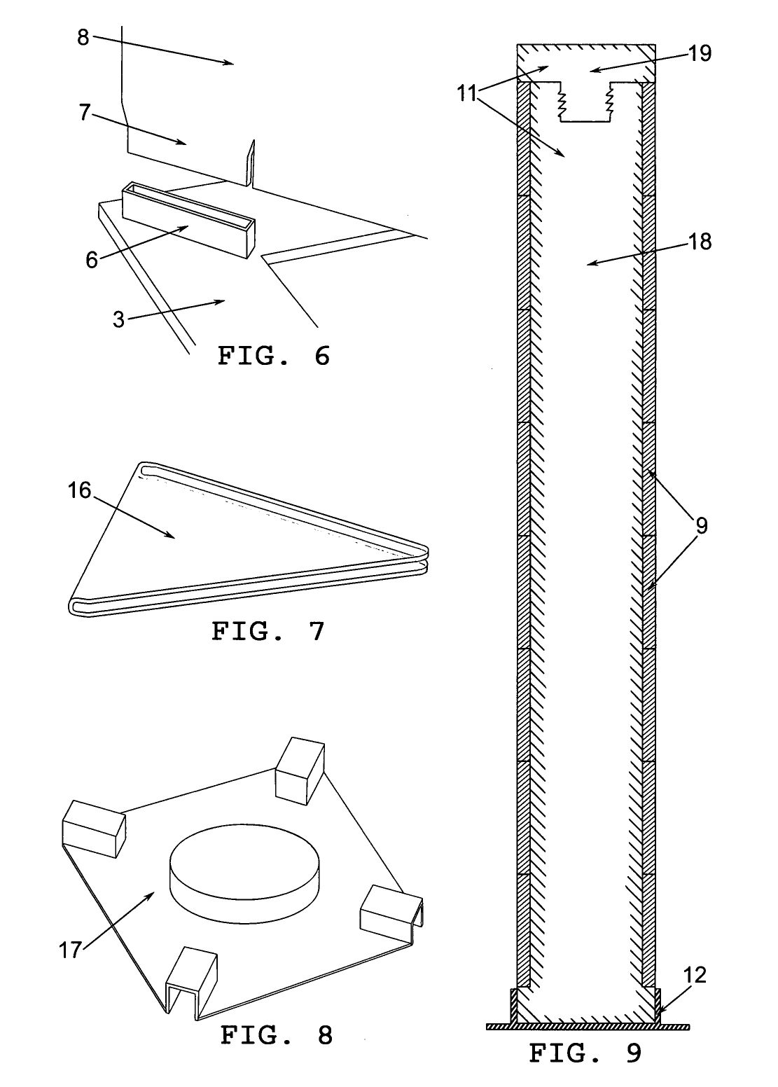

The flat rectangular frame (3) has four ‘shoes’ (6) permanently affixed to it—one at each corner. The second component, which is the central X frame assembly, has four ‘feet’ (7), which insert into the flat rectangular frame's (3) ‘shoes’ (6), fitting tightly and snugly, thereby connecting the two components (ref. also FIG. 6.)

The central X frame assembly has four rectangular shaped X frame sections (8), to each of which are permanently affixed two cylindrical sleeves (9), via flexible plastic (10). The sleeves (9) fit snugly onto a central cylindrical pole (11), thereby enabling the four X frame sections (8) to revolve around the central cylindrical pole (11), in much the same way as the two flat rectangular plates of a standard butt hinge (as used on interior and exterior doors) can partially revolve around the hinge's removable pin.

Note that the central cylindrical pole (11) is not actually visible in FIG. 1, and that only the top of the central cylindrical pole (11) is visible in FIG. 2. For a clear understanding of the central cylindrical pole (11) as used in the central X frame assembly, please refer to FIG. 9, which is a cross section of the central cylindrical pole (11).

The diameter of the central cylindrical pole (11) varies; it is the same width at the very bottom and at the very top of the pole, but narrower in the central portion where the sleeves (9) fit.

A soft plastic or rubber ‘shoe’ (12) is permanently affixed to the bottom of the central cylindrical pole (11), so that in the event of the pole touching the monitor's screen surface, no damage would occur. Note, however, that the bottom of the central cylindrical pole (11), with the soft plastic or rubber ‘shoe’ (12) permanently affixed, should nevertheless rest above the monitor's screen surface by a distance of a few millimetres.

Each X frame section (8) has a ‘foot’ (7), which inserts and fits snugly and tightly into each of the four ‘shoes’ (6), which are permanently affixed to the flat rectangular frame (3) (ref. also FIG. 6.)

Each X frame section (8) has one or two mirrors (13) permanently affixed to it by tape (14), which also acts as a hinge, allowing the mirrors (13) to hinge downwards and lie flat against the X frame section (8). The Northeast and Northwest X frame sections (8) have two mirrors (13) affixed to them, one on each side, whereas the Southeast and Southwest X frame sections (8) have only one mirror (13) attached to them, on one side only. Each mirror (13) is permanently affixed to another mirror (13) via tape (15), which also acts as a hinge, allowing the two mirrors (13) to lie flat against each other.

Because the strips of tape (14) between the X frame sections (8) and the mirrors (13), and the strips of tape (15) between the mirrors (13) themselves, all act as hinges and because the X frame sections (8) themselves hinge around the central cylindrical pole (11), the mirrors (13) and the X frame sections (8) are able to fold up ‘concertina-style’ flat against each other into a collapsed state (ref. FIG. 5), thereby facilitating the convenient storage of this second component, the central X frame assembly, when the apparatus is not in use.

The third, fourth and fifth components are three identical transparent triangular plastic clips (16), which are slid over each pair of mirrors (13) in order to keep the pair of mirrors in the same plane, thereby ensuring the player (2) has an accurate view of his or her screen segment.

The sixth component, a support cap (17), most likely made from a semi-flexible plastic or rubber, is deliberately displayed separately from the main part of the apparatus in FIG. 2 in order to allow an easier understanding of the apparatus' construction. However, as shown in FIG. 1, this support cap (17) would normally be placed on top of the central cylindrical pole (11) where, due to its shape, it would fit snugly onto the central cylindrical pole (11) and simultaneously onto one corner of each of the four X frame sections (8), thereby helping to strengthen the central X frame assembly, keeping it rigid.

Note that the mirrors (13) in the North (N) and East (E) positions are shaded to indicate that from the perspective of these two drawings (FIG. 1 and FIG. 2), only the rear non-reflective sides of the mirrors (13) are visible. By contrast it is only the reflective sides of the mirrors (13) in the West (W) position, which are visible. Therefore the mirrors (13) in the West (W) position are not shaded.

Note that the mirrors (13) in the East (E) and West (W) positions are positioned at an angle of approximately 45 degrees to the base plane of the apparatus, this being the same plane as the screen surface area (4) of the monitor onto which the apparatus is mounted, whereas the mirrors (13) in the North (N) position are positioned at an angle of approximately 30 degrees to the base plane of the apparatus. Note that no mirrors are used for the player in the South (S) playing position. He or she views their screen segment directly.

It is expected that the flat rectangular frame (3), the X frame sections (8) and the core of the central cylindrical pole (11) all be made of a durable lightweight and rigid material, probably plastic. The mirrors (13) could be of a lightweight glass type or clear plastic type. The sleeves (9) and the flexible plastic (10), which joins them to the X frame sections (8), would most likely be made from the same flexible plastic.

FIG. 3 illustrates how the computer monitor's screen area is divided into the four separate segments, one for each of the four players, and also illustrates how computer software must display information in each segment (indicated by the direction of text and whether the text is in mirror image format) for the preferred embodiment of the invention. The shaded area in FIG. 3 indicates that part of the monitor's screen area, which is unused by the computer software for the preferred embodiment of the invention.

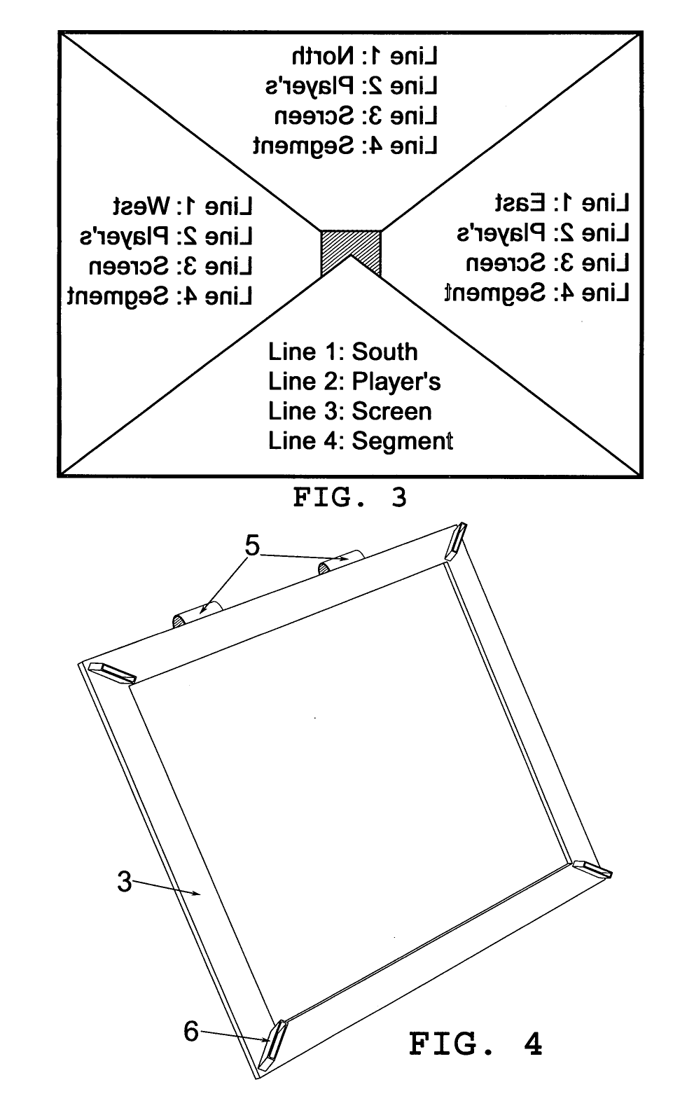

FIG. 4 displays the flat rectangular frame (3) component of the preferred embodiment of the invention, with its permanently affixed four ‘shoes’ (6) and two retaining hooks (5).

FIG. 5 illustrates the central X frame assembly of the apparatus, in its collapsed state. The four X frame sections (8) are lying flat. As mentioned earlier, two cylindrical sleeves (9) are permanently affixed to each X frame section (8) via flexible plastic (10). The sleeves (9) fit snugly onto the central cylindrical pole (11), thereby enabling the four X frame sections (8) to revolve around the central cylindrical pole (11), in much the same way as the two flat rectangular plates of a standard butt hinge (as used on interior and exterior doors) can partially revolve around the hinge's removable pin. Note that the sleeves (9) and the flexible plastic (10) have been shaded in the drawing simply as a visual aid to facilitate an easier understanding of the apparatus' construction.

A soft plastic or rubber ‘shoe’ (12) is permanently affixed to the bottom of the central cylindrical pole (11).

As mentioned earlier, each X frame section (8) has a ‘foot’ (7), which inserts and fits snugly and tightly into each of four ‘shoes’ (6), which are permanently affixed to the flat rectangular frame (3) (ref. FIG. 1, FIG. 2 and FIG. 6.)

The X frame section (8) on the top is the Southeast X frame section (8), and the X frame section (8) below it is the Northeast X frame section (8). Between these two X frame sections (8) are the two mirrors (13), which allow the player in the East playing position to view his/her screen segment. Only a tiny part of these mirrors (13) is visible in the drawing.

The X frame section (8) on the bottom is the Southwest X frame section (8), and the X frame section (8) above it is the Northwest X frame section (8). Between these two X frame sections (8) are the two mirrors (13), which allow the player in the West playing position to view his/her screen segment. Only a tiny part of these mirrors (13) is visible in the drawing.

Between the two X frame sections (8) in the middle (the Northeast and Northwest X frame sections (8)) are the two mirrors (13), which allow the player in the North playing position to view his/her screen segment. Only a tiny part of these mirrors (13) is visible in the drawing.

The tiny parts of the mirrors (13), which are visible in the drawing, are the parts of the mirrors, which are closest to the screen surface of the monitor, when the apparatus is in use.

FIG. 6 is a detail illustration of how one of the ‘feet’ (7) of one of the X frame sections (8) of the central X frame assembly slots into one of the ‘shoes’ (6) of the rectangular frame (3).

FIG. 7 is a closer view of one of the transparent triangular plastic clips (16).

FIG. 8 is a closer view of the support cap (17).

FIG. 9 is a cross section of the central cylindrical pole (11), which is part of the central X frame assembly component shown in FIG. 5. FIG. 9 shows the central cylindrical pole (11) and the sleeves (9) and the central cylindrical pole's (11) soft plastic or rubber ‘shoe’ (12). The central cylindrical pole (11) is actually comprised of two separate pieces: a lower part (18) and an upper part (19). The upper part (19) can screw into or unscrew from the lower part (18). With the upper part (19) unscrewed and separated from the lower part (18), the sleeves (9) —and therefore also the X frame sections (8) and the mirrors (13) —may be placed onto the lower part (18) and then secured by screwing the upper part (19) back in.

Although the foregoing description of the invention has only made reference to one, the preferred, embodiment of the invention, those of ordinary skill in the art will understand that various modifications of the disclosed preferred embodiment, as well as alternative embodiments, could be made within the scope of the claims that follow. Accordingly, it is not intended that the scope of the invention in any way be limited by the foregoing description, but instead be determined entirely by reference to the claims that follow.

What is claimed is:

1. A computer accessory, being an apparatus, which, when attached to a personal computer flat screen monitor or laptop (notebook type) computer monitor, effectively partitions the monitor's screen area into four segments, each one of which, as a consequence of the attachment of the apparatus to the monitor, then becomes visible to one, only, of four separate persons (players) sat around the computer monitor and apparatus in a classic North-South-East-West configuration, ideal for playing indoor games.

2. A computer accessory according to claim 1, which is collapsible, thereby providing more convenient portability, and requiring less storage space, when not in use.
